(19) United States
(12) Patent Application Publication
(10) Pub. No.: US 2025/0283477 A1
(43) Pub. Date: Sep. 11, 2025

(54) IMPELLER FOR A LIQUID PUMP

(71) Applicant: BÜHLER MOTOR GMBH, Nürnberg (DE)

(72) Inventors: Jürgen Brettschneider, Nürnberg (DE); Katherine Bee, Nürnberg (DE)

(73) Assignee: BÜHLER MOTOR GMBH, Nürnberg (DE)

(21) Appl. No.: 19/215,852

(22) Filed: May 22, 2025

Related U.S. Application Data
(63) Continuation of application No. PCT/EP2023/081459, filed on Nov. 10, 2023.

(30) Foreign Application Priority Data
Nov. 25, 2022 (DE) 10 2022 131 215.1

(51) Int. Cl. F04D 29/24; B23K 20/10; B23K 26/21

(52) U.S. Cl. CPC F04D 29/24; B23K 20/10; B23K 26/21

(57) ABSTRACT

An impeller for a liquid pump with a cover plate and a base body. An intake channel is arranged on the cover plate. A plurality of pump vanes are formed integrally with the cover plate. The base body has a receptacle for an impeller bearing bush in a central region. A cover plate is connected to the base body via at least one pump vane by means of a welding process.

### CROSS-REFERENCE TO RELATED APPLICATIONS

The present patent application claims priority from German Application No. DE 10 2022 131 215.1, filed Nov. 25, 2022, which was filed as PCT application No. PCT/EP2023/081459 (International Publication No. WO/2024/110221, published on May 30, 2024). Both applications are incorporated herein by reference in their entirety.

### BACKGROUND OF THE INVENTION

### Field of the Invention

The invention relates to an impeller for a liquid pump with a cover plate and a base body.

### Description of Related Art Including Information Disclosed Under 37 CFR 1.97 and 1.98

Impellers for liquid pumps are already known and consist of a base plate, pump vanes and a cover plate and are connected to each other by welding. In ultrasonic welding, a sonotrode is placed on the impeller in such a way that the direction of vibration acts perpendicularly on the impeller. The disadvantage is that so-called shaped sonotrodes have to be used for different impeller sizes, which result in higher acquisition, setup and manufacturing costs. During laser welding, a laser beam is applied to the impeller in such a way that the cover plate and the base plate fuse together. The disadvantage of laser welding, however, is that the laser welding system, depending on the design, is very expensive to purchase.

The object of the invention is to provide an impeller for a liquid pump in which a sonotrode can be used in ultrasonic welding in such a way that no shaped sonotrode is required for different impeller sizes, the acquisition, setup and manufacturing costs are low, a component holder can be changed quickly and the ultrasonic system can be easily coded with an automatic ultrasonic welding program call. Furthermore, an impeller is to be specified that can be easily manufactured and measured in an injection mold and is secured against falling or slipping during transport in an automatic system.

A further object of the invention is to provide an impeller for a liquid pump in which the impeller can be manufactured cost-effectively by means of laser welding. This object is achieved by the impeller for a liquid pump with a cover plate and a base body. An intake channel is arranged on the cover plate, wherein a plurality of pump vanes are formed integrally with the cover plate. The base body has a receptacle for an impeller bearing bush in a central region, and wherein the cover plate is connected to the base body via at least one pump vane by means of a welding process.

### BRIEF SUMMARY OF THE INVENTION

According to the invention, the impeller for a liquid pump has a cover plate and a base body. An intake channel is arranged on the cover plate. A plurality of pump vanes are formed integrally with the cover plate. The base body receives a receptacle for an impeller bearing bush in a central region and wherein the cover plate is connected to the base body via at least one pump vane by means of a welding process. The plurality of the pump vanes extend in the axial direction of the base body. In the central region of the base body, a receptacle for an impeller bearing bush is provided. The impeller bearing bush can be mounted in the holder before the welding process or after the welding process by pressing, injection or other fastening methods known to those skilled in the art. The base body and the cover plate with the plurality of pump vanes are connected to each other by means of a welding process in a force-fitting and/or material-fitting manner.

In a further development of the invention, the pump vanes have a uniform width at least in sections. This means that the pump blades have a uniform width over their entire length, from the root end to the tip end. However, it is also possible to design the width of the pump blades from the root end to the tip end in variable widths over the length of the pump blades. Another possibility would be to design one number of pump blades with a uniform width and the other number of pump blades with a variable width over the length of the pump blades.

The advantage is that the pump blades extend in a concave curve from the root to the tip on the cover plate, i.e., from the intake channel to an edge region of the cover plate. The concavely curved pump blades ensure a harmonious and uniform liquid distribution and reduce power losses in the impeller, which in turn leads to increased efficiency.

According to the invention, it is provided that at least one axially extending rib structure is formed in sections on at least one pump vane on a side opposite the base body. The axially extending rib structure is formed over a partial length of the pump vanes. Alternatively, the axially extending rib structure may also be formed over the entire length of the pump vanes. Also conceivable are the formation of several axially extending rib structures arranged next to one another on one or more pump vanes over a partial or entire length of the pump vanes.

In a further development of the invention, at least one crown structure extending axially in the direction of the base body is formed on the tip of at least one pump vane. A crown structure is understood to mean an axial projection that has a greater axial height and radial width than the axially extending rib structure. The crown structure is formed across the entire width of the pump blades and at the tip of at least one pump blade. The crown structure may be formed on only one pump vane or on several pump vanes. The crown structure at the tip of at least one pump vane serves to center the cover plate in the base body. Alternatively, the crown structure may also correspond to the axial height and radial width of the axially extending rib structure and vice versa. This would mean that the crown structure and the rib structure would be on the same level. Both alternatives are easy to implement, especially with multiple mold cavities, and are therefore also easy to measure.

The base body advantageously has a greater wall thickness in the central region than in an edge region. When manufacturing the base body using an injection molding process, the central region of the base body is built up with more material that is technically possible. This allows for a receptacle for a wheel bearing bush in the central region of the base body.

It is advantageous that the base body has a plurality of grooves on its end face which correspond to the pump vanes, and the base body is formed flat on its rear side.

According to the invention, the grooves are formed deeper in the central region than in the edge region. This results from the fact that the grooves are formed parallel to the rear side of the base body. Also, due to the greater wall thickness of the base body in the central region, the grooves are formed deeper in the central region than in the edge region. Since the pump vanes are all on the same level or height and correspond to the grooves of the base body, the grooves are formed deeper in the central region of the base body than in the edge region of the base body. The plurality of pump vanes engage in grooves that are formed deeper in the central region, thus securing the base body and the cover plate against falling or slipping during transport in an automatic system.

It is advantageous that the grooves extend to the edge region of the base body and define recesses in the edge region of the base body. Each groove defines a recess in the edge region of the base body. In an alternative, the grooves may not extend to the edge region of the base body. In this case, the base body would have a closed surface without any recesses in the edge region. During the manufacture of the impeller, the crown structure at the tip of at least one pump blade engages into the recesses in the edge region of the base body and forms a closed edge region.

According to the invention, the recesses in the edge region of the base body form a tooth structure. The shape of the tooth structure corresponds to several saw teeth in the edge region of the base body. Due to the correspondence of the pump vanes with the grooves in the base body, the grooves are also formed to be concave. The crown structure engages the tooth structure as a counter contour.

In a further development, the base body has at least one recess on its rear side in the central region. Due to its production by injection molding, the base body has a greater wall thickness than the edge region. By means of the at least one recess, material is removed from the rear side of the base body in the central region. During the welding process, the base body is heated and then cooled from the edge region to the central region. The at least one recess in the central region enables constant cooling in the edge region and central region after the welding process, since there is less material in the central region due to the at least one recess. This also has the advantage that the base body cannot warp when cooling down.

Alternatively, the base body may not have any recesses on its rear side in the central region. This can be the case if the pump blades are formed quite flat in width and height. In this case, the central region can also be formed with less material.

One advantage is that at least one energy director is formed in a flat plane within at least one groove, which is in a material-fitting connection with the rib structure of the pump vanes after welding. The at least one energy director is inserted on a flat plane in the base body and fuses with the rib structure of the pump vanes during welding. By inserting at least one energy director on a flat plane in the base body, the weld seam is at the same height everywhere, i.e., in every groove; this means that the wall thickness up to the weld seam is the same everywhere. As a result, the sound introduced, for example in ultrasonic welding, travels the same path everywhere. A further advantage is that the base body can be more easily manufactured and measured in the injection molding tool. This also applies to multiple mold cavities.

In a further development, the cover plate is connected to the base body by means of laser welding or ultrasonic welding. In laser welding, the base body is made of a laser-transparent material and the cover plate with the pump blades is made of a laser-absorbing material. In ultrasonic welding, the base body and the cover plate with the plurality of pump vanes are made of a thermoplastic material. By forming the cover plate and the base body out of thermoplastic material, it is possible to connect the cover plate to the base body in a force-fitting and/or material-fitting manner using a welding process.

According to the invention, a sonotrode is placed on the rear side of the base body during ultrasonic welding. The flat rear side of the base body allows the sonotrode to be placed flat, thus creating a longer weld seam. The sonotrode can be used for different impeller sizes due resting on the rear side of the base body in a flat manner. This means that no shaped sonotrode is required for different impeller sizes and results in lower acquisition and setup costs. This also means that there is no interference with the ultrasonic system, as only the component holder needs to be replaced if the impeller size is different. This results in lower manufacturing costs for the impeller, the component holder can be changed quickly and the ultrasonic system can be easily coded with an automatic ultrasonic welding program call. A further advantage is that a uniform material thickness is achieved over the entire length of the weld.

It is advantageous that a hold-down mask is placed on the rear side of the base body during laser welding. Due to the flat rear side of the base body, the hold-down mask can be placed flat and thus form a longer weld seam. The hold-down mask can be used for different impeller sizes due to it resting on the rear side of the base body in a flat manner. This means that no changes to the hold-down mask are required for different wheel sizes and results in lower acquisition and setup costs. A further advantage is that a uniform material thickness is achieved over the entire length of the weld.

In a further development, the base body and the cover plate each have at least one corresponding recess which is provided for fastening in a tool. The recess in the cover plate and the base body allows them to be inserted into the welding tool in the correct position. Alternatively, the recess in the cover plate and the base body can also be omitted.

The invention is not limited to the mentioned exemplary embodiments. Rather, all embodiment variants that are implemented within the scope of the expert activity and minor expert changes are included.

### BRIEF DESCRIPTION OF SEVERAL VIEWS OF THE DRAWINGS

The invention will now be described in more detail below with reference to the exemplary embodiments shown in the drawings. In the figures:

FIG. 1 shows a plan view of the impeller according to the invention;

FIG. 2 shows a spatial representation of the cover plate;

FIG. 3 shows a top view of the base body;

FIG. 4 shows a sectional view of the base body according to FIG. 3;

FIG. 5 shows a rear view of the base body according to FIG. 3;

### DETAILED DESCRIPTION OF THE INVENTION

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

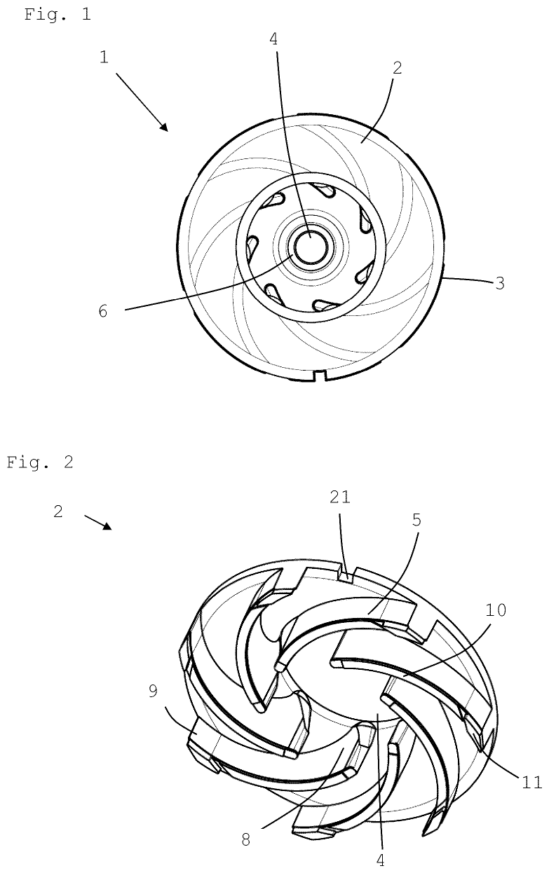

FIG. 1 shows a plan view of the impeller 1 according to the invention for a liquid pump, having a cover plate 2 and a base body 3, wherein an intake channel 4 is arranged on the cover plate 2. A plurality of pump vanes 5 (not shown here) are formed integrally with the cover plate 2. The base body 3 has a receptacle 7 for an impeller bearing bush (not shown here) in a central region 6, and wherein the cover plate 2 is connected to the base body 3 via at least one pump vane 5 by means of a welding process. The cover plate 2 with the plurality of pump vanes 5 and the base body 3 are made of a thermoplastic material.

FIG. 2 shows a spatial representation of the cover plate 2. An intake channel 4 is arranged in the center of the cover plate 2. A plurality of pump vanes 5 are formed integrally with the cover plate. The pump vanes 5 have a uniform width at least in sections and extend from a root end 8 to a tip end 9 in a concave curve on the cover plate 2. At least one axially extending rib structure 10 is formed in sections on at least one pump vane 5 on a side opposite the base body 3. On the tip 9 of at least one pump vane 5 at least one crown structure 11 extending axially in the direction of the base body 3 is formed. At least one recess 21 is provided on the cover plate 2 in an edge region, which corresponds to a recess 21 on the base body 3. The at least one recess 21 serves to fasten the cover plate 2 and the base body 3 in a tool.

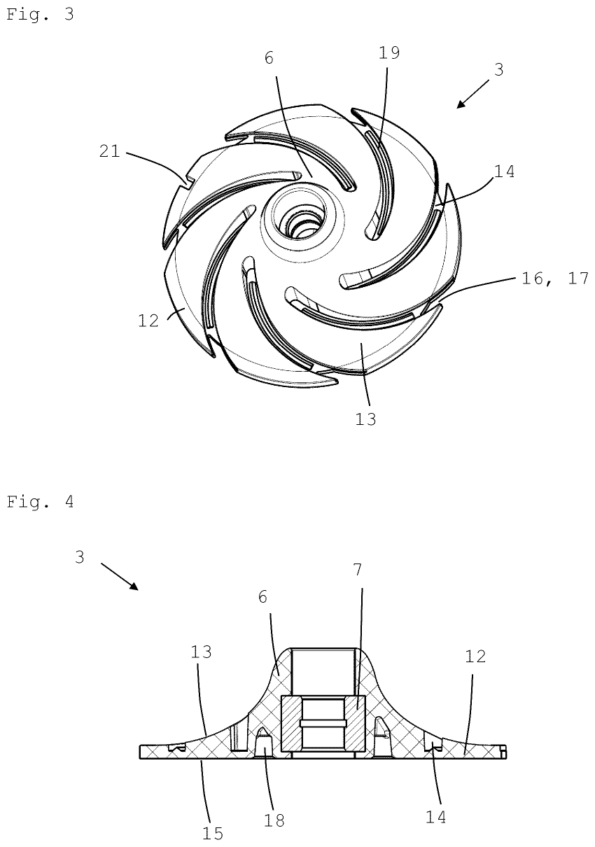

FIG. 3 shows a plan view of the base body 3 with a central region 6 which has a greater wall thickness than in an edge region 12. On the end face 13 of the base body 3 a plurality of grooves 14 are formed, which correspond to the plurality of the pump vanes 5. Within at least one groove 14, at least one energy director 19 is formed in a flat plane, which is in material-fitting connection with the rib structure 10 of the pump vanes 4 after the welding process. The grooves 14 are deeper in the central region 6 than in the edge region 12. Recesses 16 are defined in the edge region 12. The grooves 14 extend to the edge region 12 and merge here into the recesses 16. The recesses 16 form a tooth structure 17 in the form of several saw teeth in the edge region 12 of the base body 3. The tooth structure 17 forms the counter contour to the crown structure 11. At least one recess 21 is provided on the base body 3 in the edge region 12, which corresponds to a recess 21 on the cover plate 2. The at least one recess 21 serves to fasten the cover plate 2 and the base body 3 in a tool.

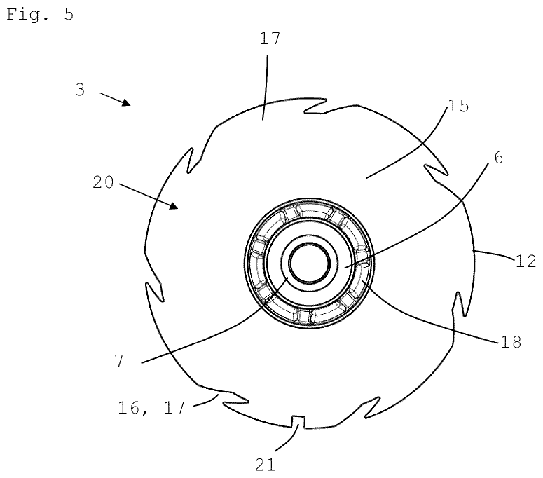

FIG. 4 shows a sectional view of the base body 3 according to FIG. 3. The base body 3 has a greater wall thickness in the central region 6 than in the edge region 12. In the central region 6, a receptacle 7 for an impeller bearing bush is formed, into which an impeller bearing bush is received before or after the welding process by pressing, injection or other fastening methods known to the person skilled in the art. On the end face 13 of the base body, a plurality of grooves 14 are formed, in which at least one energy director 19 is formed in a flat plane. On the rear side 15 the base body 3 is formed flat and has at least one recess 18 in the central region 6.

FIGS. 3-5 shows a rear view of the base body 3 according to FIG. 3. On the rear side 15 of the base body 3, a receptacle 7 for an impeller bearing bush and at least one recess 18 are formed in the central region 6. The grooves 14 extend into the edge region 12 and define recesses 16 that form a tooth structure 17 in the form of several saw teeth. A recess 21 is formed in the edge region 12, which is designed for fastening the base body 3 in a tool. A sonotrode 20 or a hold-down mask is placed on the rear side 15 of the base body 3 during ultrasonic welding or laser welding.

Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

### LIST OF REFERENCE NUMBERS

1. Impeller
2. Cover plate
3. Basic body
4. Intake channel
5. Pump vane
6. Central region
7. Receptacle
8. Root
9. Tip
10. Rib structure
11. Crown structure
12. Edge region of base body
13. End face
14. Grooves
15. Rear side
16. Recess
17. Tooth structure
18. Depression
19. Energy director
20. Sonotrode
21. Recess

What is claimed is:

1. An impeller for a liquid pump, the impeller comprising:
(a) a cover plate and a base body, (b) an intake channel is arranged on the cover plate, (c) a plurality of pump vanes are formed integrally with the cover plate, (d) the base body has a receptacle for an impeller bearing bush in a central region, and (e) the cover plate is connected to the base body via at least one pump vane by means of a welding process.

2. The impeller according to claim 1, further comprising a root end and a tip end on the cover plate, wherein the pump vanes have a uniform width at least in sections and extend in a concave curve from the root end to the tip end on the cover plate.

3. The impeller according to claim 1, wherein at least one axially extending rib structure is formed in sections on at least one pump vane on a side opposite the base body.

4. The impeller according to claim 1, wherein at least one crown structure extending axially in the direction of the base body is formed on the tip end of at least one pump vane.

5. The impeller according to claim 1, wherein the base body has a greater wall thickness in the central region than in an edge region.

6. The impeller according to claim 1, wherein the base body has a plurality of grooves on an end face which correspond to the pump vanes and wherein the base body is formed flat on its rear side.

7. The impeller according to claim 6, wherein the grooves are formed deeper in the central region than in the edge region.

8. The impeller according to claim 6, wherein the grooves extend into the edge region of the base body and define recesses in the edge region of the base body.

9. The impeller according to claim 8, wherein the recesses in the edge region of the base body form a tooth structure.

10. The impeller according to claim 1, wherein the base body has at least one recess on its rear side in the central region.

11. The impeller according to claim 1, wherein at least one energy director is formed in a flat plane within at least one groove, which is in material-fitting connection with the rib structure of the pump vanes after welding.

12. The impeller according to claim 1, wherein the cover plate is connected to the base body by means of laser welding or ultrasonic welding.

13. The impeller according to any claim 10, wherein a sonotrode is placed on the rear side of the base body during ultrasonic welding.

14. The impeller according to claim 10, wherein a hold-down mask is placed on the rear side of the base body during laser welding.

15. The impeller according to claim 1, wherein the base body and the cover plate each have at least one corresponding recess which is provided for fastening in a tool.
